(19) United States
(12) Patent Application Publication
(10) Pub. No.: US 2012/0123873 A1
(43) Pub. Date: May 17, 2012

(54) METHOD FOR PROVIDING DATA SERVICE AND SYSTEM FOR PROVIDING DATA SERVICE APPLYING THE SAME

(75) Inventors: Kwang-yong LEE, Seoul (KR); Eui-hyeon Hwang, Yongin-si (KR); Beom-soo Cho, Seongnam-si (KR)

(73) Assignee: Samsung Electronics Co., Ltd., Suwon-si (KR)

(21) Appl. No.: 13/283,016

(22) Filed: Oct. 27, 2011

(30) Foreign Application Priority Data
Nov. 12, 2010 (KR) 10-2010-0112894

(51) Int. Cl. G06Q 30/02; G06Q 30/04; G06F 15/16

(52) U.S. Cl. 705/14.69; 709/203; 705/35

(57) ABSTRACT

A method for providing a data service and a system for providing a data service applying the same are provided. The method includes selecting a content that is assigned a data assignment quantity indicating a quantity sufficient for using a service; comparing a data generation quantity indicating a quantity of data generated by a user and the data assignment quantity; and performing the service for the data generated by the user according to a result of the comparison.

### PRIORITY

This application claims priority to Korean Patent Application No. 10-2010-0112894, filed on Nov. 12, 2010, in the Korean Intellectual Property Office, the entire content of which is incorporated herein by reference.

### BACKGROUND

1. Field of the Invention

The present invention relates generally to a method for providing a data service and a system for providing a data service applying the same, and more particularly, to a method for providing a data service, which provides a variety of services using a terminal through mobile communications, and a system for providing a data service applying the same.

2. Description of the Related Art

Currently, native applications are used to provide advertisements in a mobile terminal. In particular, an advertisement is inserted into an application and presented to users along with the application.

However, if a user does not install the application for presenting the mobile advertisement, the mobile advertisement is ineffective. Also, an installed application may not be updated frequently, and therefore, only one advertisement may be inserted into the application, which causes inefficiency.

As such, conventional advertisement deliver methods in mobile devices are ineffective inefficient. Therefore, there is a demand for a method for more efficiently providing an advertisement on mobile devices.

### SUMMARY OF THE INVENTION

Accordingly, the present invention is provided to address the above-mentioned problems and/or disadvantages and to offer at least the advantages described below.

Embodiments of the present invention provide a method for providing a data service that selects content that is assigned a quantity sufficient for using a service, compares a data generation quantity, which is a quantity of data generated by a user, and a data assignment quantity, which is a quantity assigned to the content, and performs a service for data generated by the user based on a result of the comparison.

According to one aspect of the present invention, a method for providing a data service is provided. The method includes selecting a content that is assigned a data assignment quantity indicating a quantity sufficient for using a service, comparing a data generation quantity indicating a quantity of data generated by a user and the data assignment quantity, and, performing the service for the data generated by the user according to a result of the comparison.

According to another aspect of the present invention, a method for providing a data service of an external server in a data service providing system is provided. The data service providing system includes a terminal and the external server, the method comprising: from the terminal, receiving a data generation quantity which is a quantity of data generated by a user, a data assignment quantity which is a quantity assigned to a content, and a service request for performing a service for data generated by the user, performing the requested service, and charging for the service using the data generation quantity and the data assignment quantity.

Additional aspects and advantages of the embodiments will be set forth in the detailed description, will be obvious from the detailed description, or may be learned by practicing the embodiments.

### BRIEF DESCRIPTION OF THE DRAWINGS

The above and other aspects, advantages, and salient features of the invention will become apparent to those skilled in the art from the following detailed description, when taken in conjunction with the accompanying drawings, in which:

FIG. 1 is a diagram illustrating a system for providing a data service according to an embodiment of the present invention;

FIG. 2 is a flowchart illustrating a method for providing a data service according to an embodiment of the present invention

FIGS. 3A to 3C are diagrams illustrating a process of adding an advertisement content to message text according to an embodiment of the present invention;

FIGS. 4A to 4B are diagrams illustrating a case in which an advertisement content is touched for a prolonged period according to an embodiment of the present invention;

FIG. 5 is a diagram illustrating diverse types of advertisement contents according to an embodiment of the present invention;

FIGS. 6A and 6B are diagrams illustrating a terminal according to an embodiment of the present invention; and

FIG. 7 is a diagram illustrating a system for providing a data service including an advertisement server according to an embodiment of the present invention.

### DETAILED DESCRIPTION OF EMBODIMENTS OF THE PRESENT INVENTION

Hereinafter, embodiments of the present invention are described in greater detail with reference to the accompanying drawings.

In the following description, same reference numerals are used for the same elements when they are depicted in different drawings. The matters defined in the description, such as detailed construction and elements, are provided to assist in a comprehensive understanding of the embodiments of the present invention. Thus, it is apparent that the embodiments of the present invention can be carried out without those specifically defined matters. Also, functions or elements known in the related art are not described in detail since they would obscure the embodiments of the present invention with unnecessary detail.

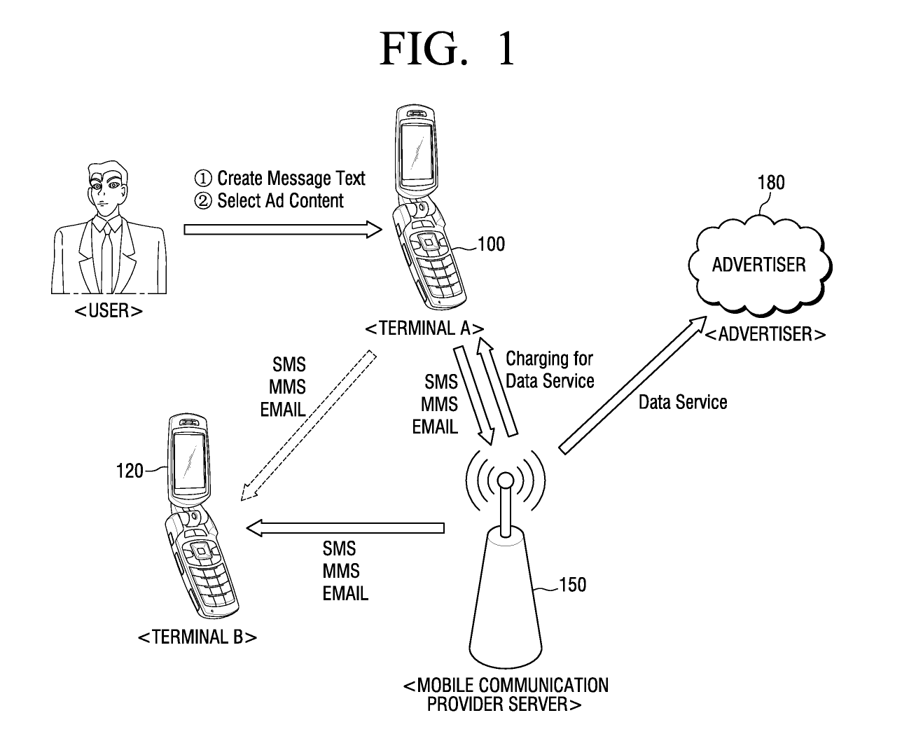

FIG. 1 is a diagram illustrating a system for providing a data service according to an embodiment of the present invention.

Referring to FIG. 1, a system for providing a data service includes a terminal A 100, a terminal B 120, a mobile communication provider server 150, and an advertiser 180. The terminal A 100 transmits a message to terminal B 120. The mobile communication provider server 150 is provided by a mobile communication provider to provide a variety of services to terminals, and the mobile communication provider server 150 asks terminals or advertisers to pay a charge corresponding to a service. The advertiser 180 provides an advertisement to be displayed on the terminal A 100 and terminal B 120.

The system shown in FIG. 1 inserts an advertisement content regarding an advertiser into text of a message and transmits the advertisement content along with the message. Also, the mobile communication provider server 150 charges the user and the advertiser separately for the service, such as by sending a message or charges only to the advertiser. Since the system for providing the data service provides the data service in the above-described process, a user can receive a discount on a charge for the data service by adding the advertisement content to the text of the message.

A process for providing a data service is described in detail below. The data service in FIG. 1 refers to a data service for transmitting a message, such as a Short Message Service (SMS), a Multimedia Messaging Service (MMS), and an emailing service.

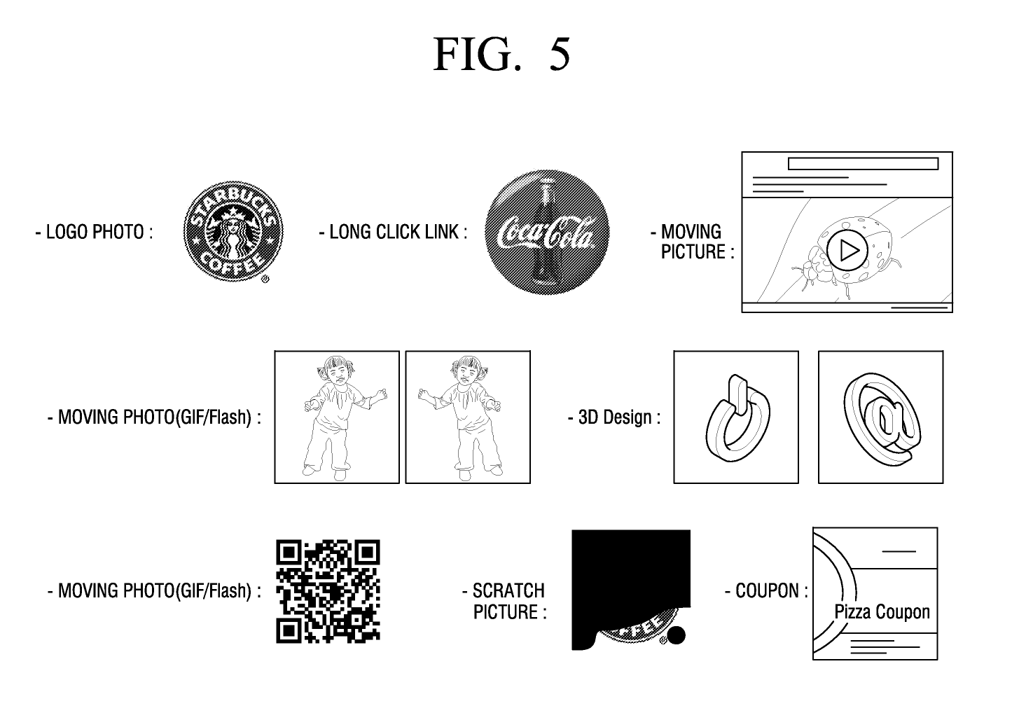

The terminal A 100 creates text of a message to be transmitted according to a user's manipulation. The terminal A 100 also selects advertisement content according to a user's manipulation. The advertisement content recited herein refers to content that includes advertisement content regarding the advertiser 180. The advertisement content may include at least one of a still image, a moving picture and a media file. Various examples of advertisement contents are illustrated in FIG. 5.

The advertisement content is assigned a data assignment quantity, which is a quantity of advertisement contents sufficient to use the data service. The data assignment quantity is used to offer users a discount of a predetermined amount on the data service in return for adding the advertisement content to the message. For example, if the data assignment quantity for the advertisement content is 100 bytes, a charge corresponding to the 100 bytes is discounted from a data service charge for the created message. The mobile communication provider server 150 asks the advertiser 180 to pay for the data of 100 byte.

Also, the terminal A 100 may select a plurality of advertisement contents according to a user's manipulation. In this case, the data assignment quantity is a sum of data quantities assigned to the plurality of advertisement contents. Therefore, the user may increase a discount rate on the data service charge by adding more advertisements.

As described above, in order to receive the discount using the advertisement content, the terminal A 100 transmits data on the message including the selected advertisement content to the mobile communication provider server 150. The terminal A 100 also transmits information for performing the service, information indicating a data generation quantity, and information indicating the data assignment quantity to the mobile communication provider server 150 along with the data on the message.

The information for performing the service refers to information that is necessary for transmitting the message created by the terminal A 100 to the terminal B 120. For example, the information for performing the service may include telephone numbers of the terminal A 100 and the terminal B 120.

The data generation quantity is a quantity of data that is generated by the message created by the user of the terminal A 100. In other words, the data generation quantity refers to a quantity of data to be transmitted to the mobile communication provider server 150.

The mobile communication provider server 150 performs the data service using the received data service-related information. Specifically, the mobile communication provider server 150 transmits the message including the advertisement content to the terminal B 120. The data service-related information includes the data on the message, the information for performing the service, the information on the data generation quantity, and the information on the data assignment quantity.

The mobile communication provider server 150 asks the user and the advertiser to pay for the data service using the information on the data generation quantity and the information on the data assignment quantity.

More specifically, if the data generation quantity is less than or equal to the data assignment quantity, the mobile communication provider server 150 only charges the advertiser 180, which is a main agent of the advertisement content, for the data service. Since the quantity of data assigned to the advertisement content is greater than the quantity of data generated by the message, a 100% discount on the charge for the message is offered. Accordingly, the mobile communication provider server 150 does not charge the user for the data service and charges the advertiser 180 for the data service.

However, if the data generation quantity is greater than the data assignment quantity, the mobile communication provider server 150 charges the advertiser 180 for the data assignment quantity and charges the user for the remaining data after the data assignment quantity is deducted from the data generation quantity. Since the quantity of data assigned to the advertisement content is less than or equal to the quantity of data generated by the message, the advertiser 180 pays the charge in part and the user pays the discounted charge.

Through the system for providing the data service described above, the terminal A 100 transmits the message including the advertisement content to the terminal B 120. In this system, the user of the terminal A 100 may receive the discount on the data service charge by adding the advertisement content to the message. Also, the advertiser 180 advertises using the data service for transmitting the message, which is used by most of the users.

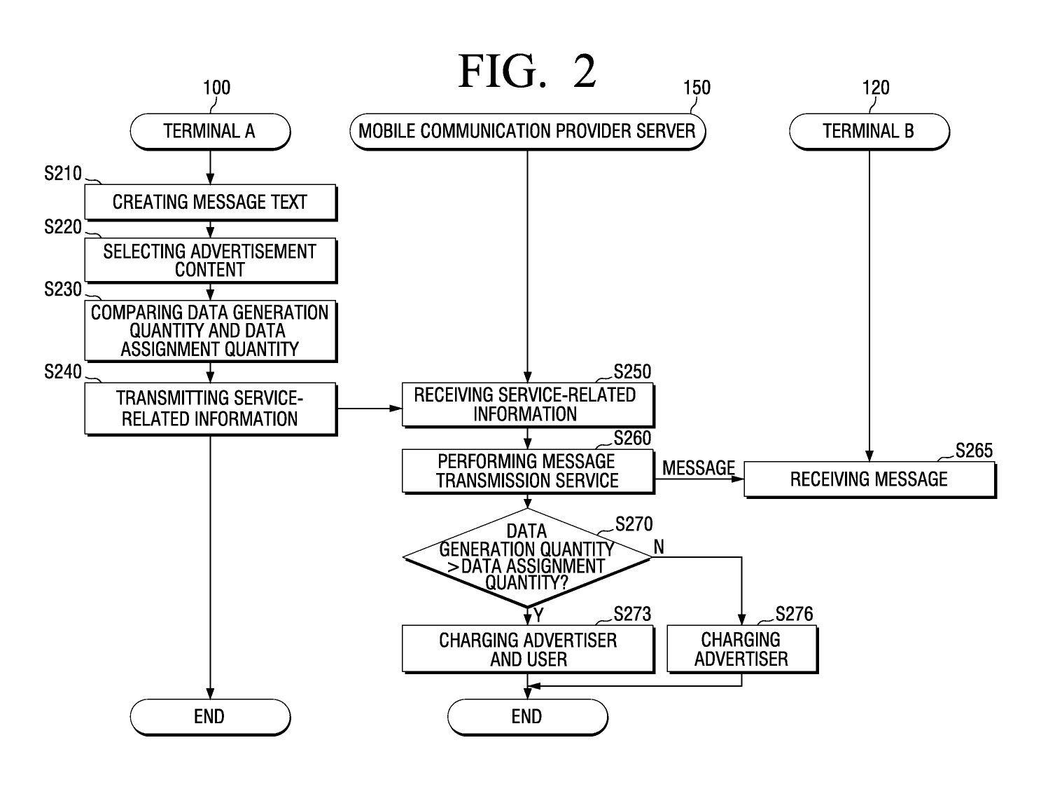

Hereinafter, a method for providing a data service is with reference to FIG. 2. FIG. 2 is a flowchart illustrating a method for providing a data service according to an embodiment of the present invention.

Referring to FIG. 2, the terminal A 100 creates text of a message to transmit according to a user's manipulation, in step 5210. The terminal A 100 also selects an advertisement content, and adds the advertisement content to the text of the message according to a user's manipulation, in step 5220. The advertisement content recited herein refers to content including an advertisement content regarding the advertiser 180 and may be a still image or a moving picture including an advertisement content, such as illustrated in FIG. 5, for example.

The terminal A 100 may select a plurality of advertisement contents according to a user's manipulation. In this case, a data assignment quantity is a sum of data quantities assigned to the plurality of contents. Accordingly, the user may increase a discount rate on the data service charge by adding more advertisements.

After the advertisement contents are selected, the terminal A 100 compares a data generation quantity caused by creating the message and a data assignment quantity of the advertisement content, in step S230. Based on the comparison results, the terminal A 100 performs a service for message data generated by the user. To achieve perform the service, the terminal A 100 transmits service-related information to the mobile communication provider server 150, in step 5240. The data service-related information includes data of the message, information for performing the service, information on the data generation quantity, and information on the data assignment quantity.

As described above, in order to receive a discount on the service charge using the advertisement content, the terminal A 100 transmits data on the message including the selected advertisement content to the mobile communication provider server 150. The terminal A 100 also transmits the data on the message along with the information for performing the service, the information on the data generation quantity, and the information on the data assignment quantity.

The mobile communication provider server 150 receives the service-related information from the terminal A 100, in step 5250. The mobile communication provider server 150 performs the data service to transmit the message using the service-related information, in step 5260. More specifically, the mobile communication provider server 150 transmits the message including the advertisement content to the terminal B 120.

After the message is transmitted, the terminal B 120 receives the message from the mobile communication provider server 150, in step 5265.

The mobile communication provider server 150 charges the user and the advertiser for the data service using the data generation quantity and the data assignment quantity.

More specifically, the mobile communication provider server 150 determines whether the data generation quantity is greater than the data assignment quantity, in step 270. If the data generation quantity is greater than the data assignment quantity, the mobile communication provider server 150 charges the advertiser 180, which is a main agent of the advertisement content, for the data assignment quantity, and charges the user for the remaining data after the data assignment quantity is deducted from the data generation quantity, in step 5273. Since the quantity of data assigned to the advertisement content is less than or equal to the quantity of data generated by the message, the advertiser 180 pays only a part of the charge and the user pays the rest of the discounted charge.

However, if the data generation quantity is less than or equal to the data assignment quantity, the mobile communication provider server 150 charges only the advertiser 180, which is a main agent of the advertisement content, for the data service, in step 5276. Since the quantity of data assigned to the advertisement content is greater than the quantity of data generated by the message, a 100% discount on the charge for the message is offered. Accordingly, the mobile communication provider server 150 does not charge the user for the data service and charges the advertiser 180 for the data service.

According to the method for providing the data service as described above, the terminal A 100 transmits the message including the advertisement content to the terminal B 120. According to this process, the user of the terminal A 100 can receive a discount on the data service charge by adding the advertisement content to the message. The advertiser 180 can also provide advertisements using the data service for transmitting the message, which is used by most users of mobile terminals.

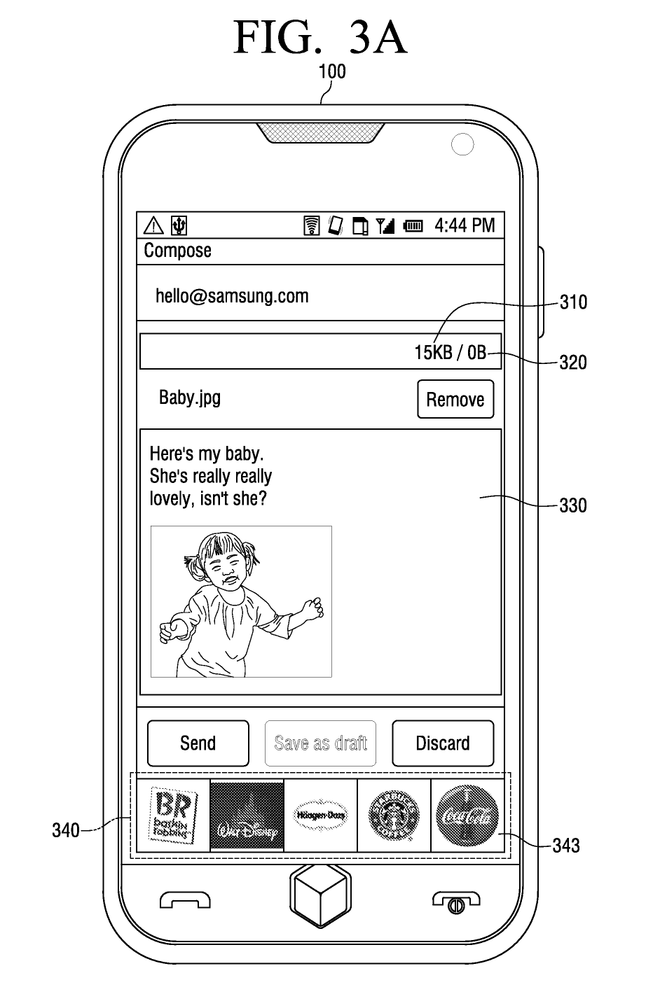

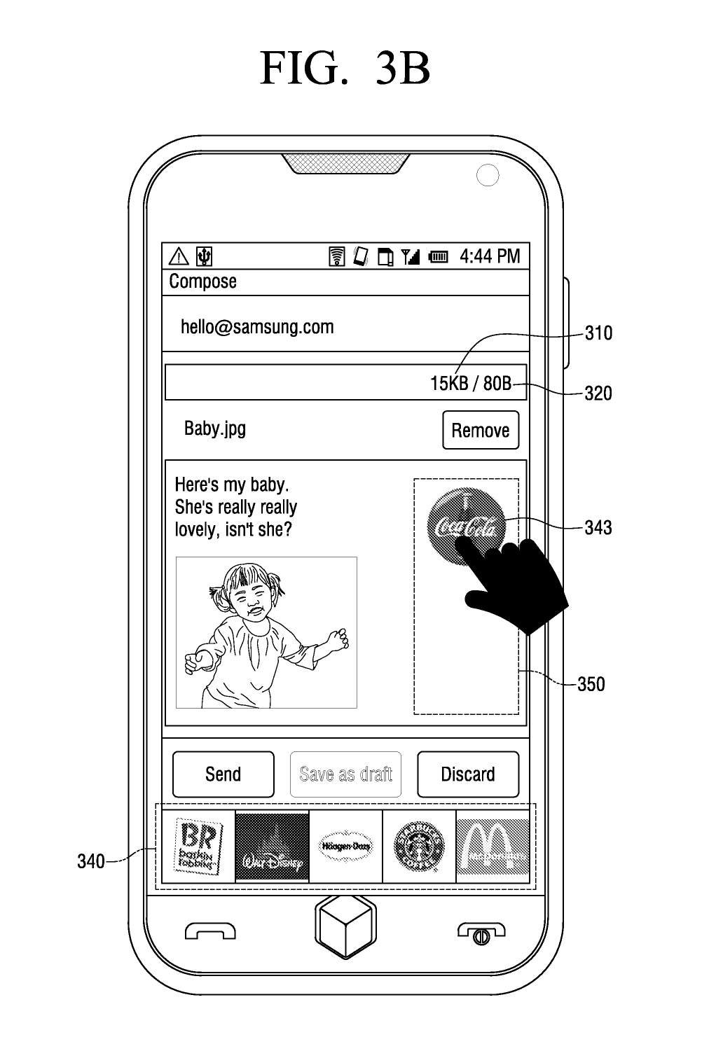

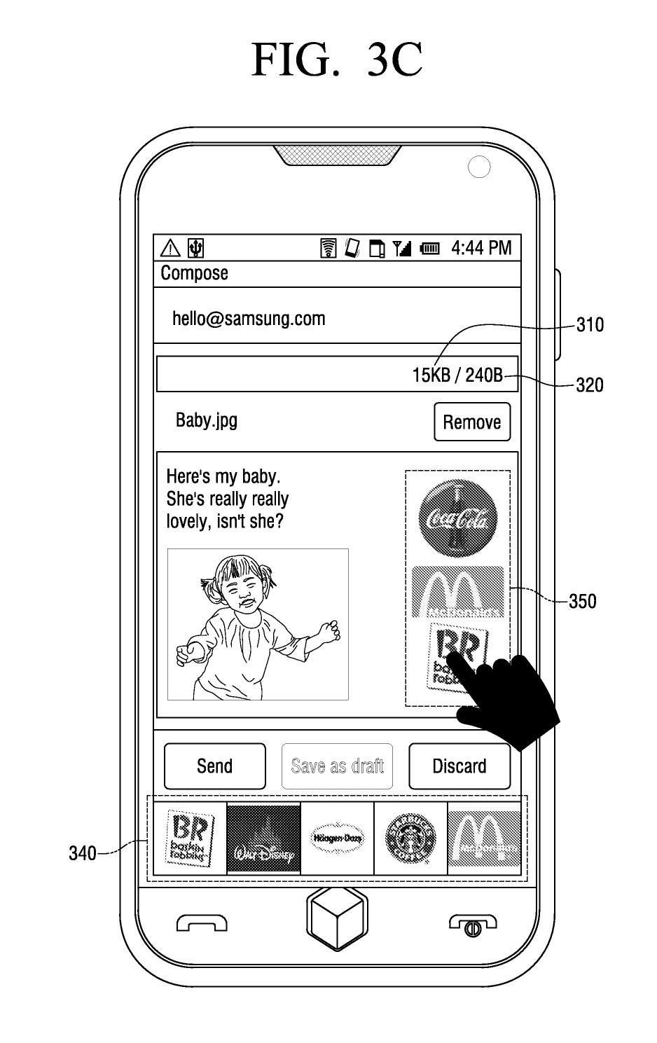

Hereinafter, a process of adding an advertisement content to a message text is described with reference to FIGS. 3A to 3C. FIGS. 3A to 3C are diagrams illustrating a process of adding an advertisement content to a message text according to an embodiment of the present invention.

FIG. 3A illustrates the terminal A 100 on which a message create screen is displayed.

Referring to FIG. 3A, the message create screen includes a data generation quantity 310, a data assignment quantity 320, a message create area 330, and an advertisement content display area 340.

As shown in FIG. 3A, advertisement contents included in the advertisement content display area 340 are displayed in the form of a stamp. The depiction of a stamp is based on the idea that payment of the cost of sending letters is made by buying a stamp and sticking the stamp on a message to be sent. In other words, the terminal A 100 provides the advertisement content in the form of a stamp so that the user can intuitively understand that the advertisement content pays or discounts the charge for the message transmission. However, although a stamp is used in the present example, the advertisement content may be displayed in other forms in accordance with embodiments of the present invention.

In FIG. 3A, a user can see that the indicated data generation quantity 310 is 15 KB. However, the data assignment quantity 320 is still OB, since the user has not inserted an advertisement content into text of the message.

In this state, if the user drags and drops a first advertisement content 343 into the message create area 330 as shown in FIG. 3A, the terminal A 100 inserts the first advertisement content 343 into an advertisement content insertion area 350 as shown in FIG. 3B, and the data assignment quantity 320 increases to 80B as the first advertisement content 343 is inserted.

If the user inserts three advertisement contents into the advertisement content insertion area 350 as shown in FIG. 3C, the data assignment quantity 320 further increases. Accordingly, it can be seen from FIG. 3C that the data assignment quantity 320 becomes 240B.

If the message is transmitted with the three advertisement contents inserted as shown in FIG. 3C, the user receives a discount of an amount corresponding to 240B on a data service charge for 15 KB. In other words, the mobile communication provider server 150 charges the user for 14.76 KB and charges the advertiser 180 for 240B.

As described above, the user can easily insert the advertisement content into the message and can receive the discount on the data service charge up to the data assignment quantity assigned to the inserted advertisement content.

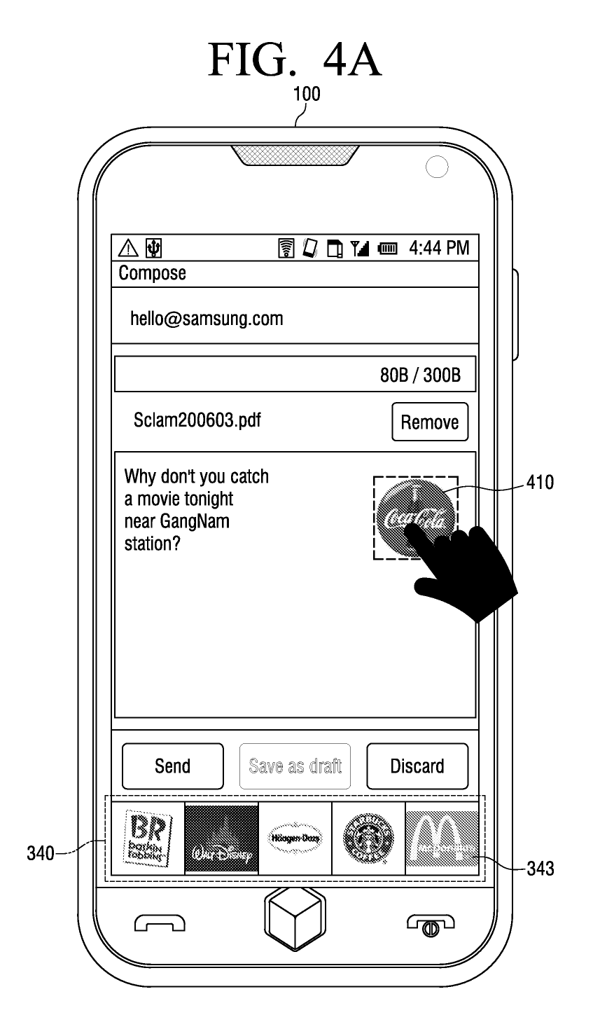

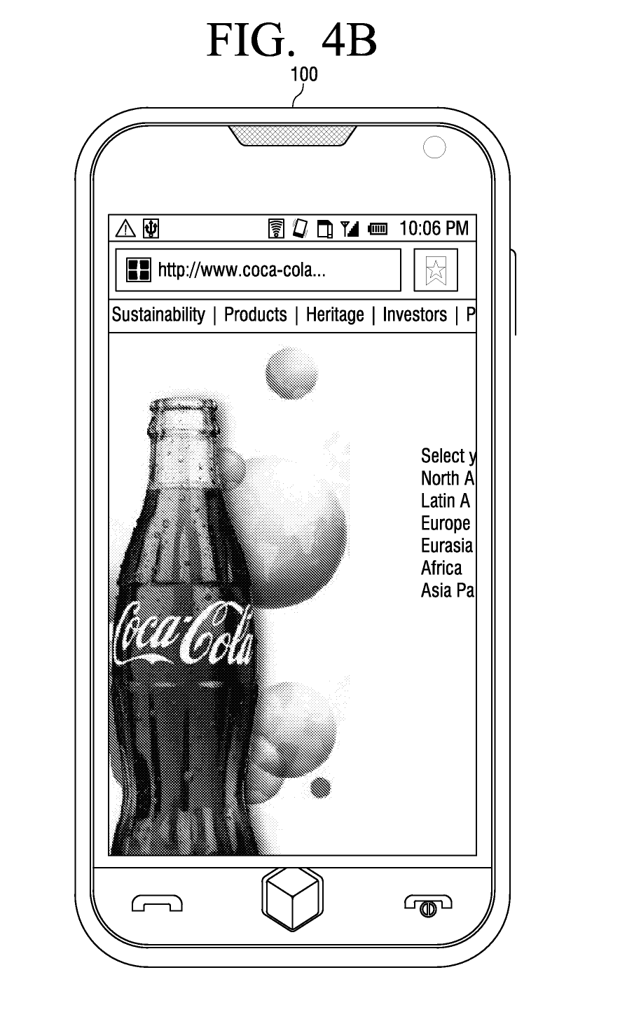

FIGS. 4A and 4B are diagrams illustrating a case in which an advertisement content is touched for a prolonged period according to an embodiment of the present invention. FIG. 4A illustrates a case in which a long touch manipulation is input into a screen area on which a specific advertisement content 410 inserted to a message is displayed. As described above, if the user provides the long touch is input to the specific advertisement content 410, the terminal A 100 accesses a home page of an advertiser corresponding to the specific advertisement content 410.

In FIGS. 4A and 4B, the manipulation input by the user is a long touch manipulation and the function performed by the long touch is a function of accessing a homepage. However, although a long touch and accessing a homepage are provided as examples, other manipulations for the advertisement content can be input and other corresponding functions may be performed, in accordance with other embodiments of the present invention.

As described above, if a specific manipulation is input to the advertisement content, the terminal A 100 may perform a function corresponding to the advertisement content.

FIG. 5 is a diagram illustrating various types of advertisement contents according to an embodiment of the present invention. As shown in FIG. 5, the advertisement contents may be a logo photo, a photo for long click link, a moving picture, a moving photo, a 3-dimensional design, a bar code, a scratch picture, a coupon, etc.

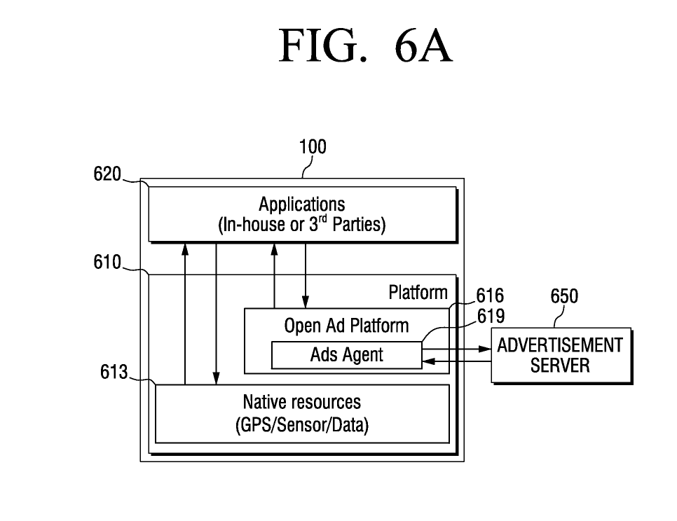

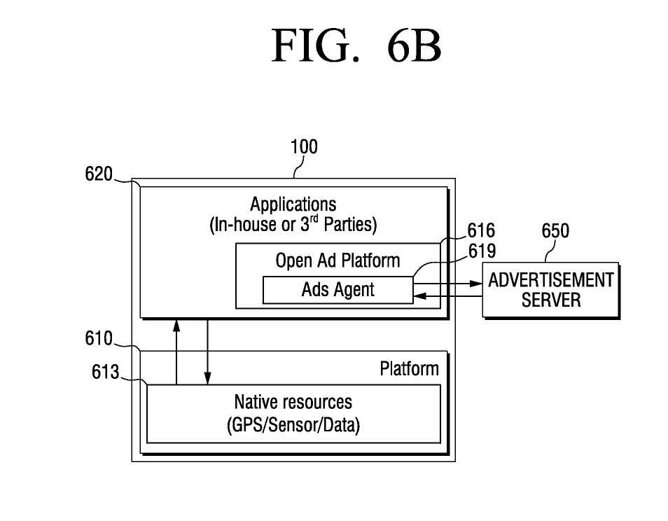

FIGS. 6A and 6B are diagrams illustrating a terminal according to an embodiment of the present invention. As shown in FIGS. 6A and 6B, the terminal A 100 includes a platform unit 610 and an application unit 620.

The platform unit 610 processes a native resource and transmits the native resource to the application unit 620. The platform unit 610 includes a native resource unit 613 and an open ADvertisement (AD) platform 616.

The native resource unit 613 stores various data resources detected by sensors.

The open AD platform 616 displays an advertisement content according to a user setting or an application function using the stored advertisement data. In other words, the open AD platform 616 displays the advertisement content on a message create screen and performs a function regarding the advertisement content. Also, the open AD platform 616 includes an AD agent 619. The AD agent 619 receives the advertisement content from an advertisement server 650, and stores and manages the advertisement content.

The function of providing the advertisement content is performed by the open AD platform 616. The open AD platform 616 may be included in the platform unit 610 as shown in FIG. 6A or in the application unit 620 as shown in FIG. 6B.

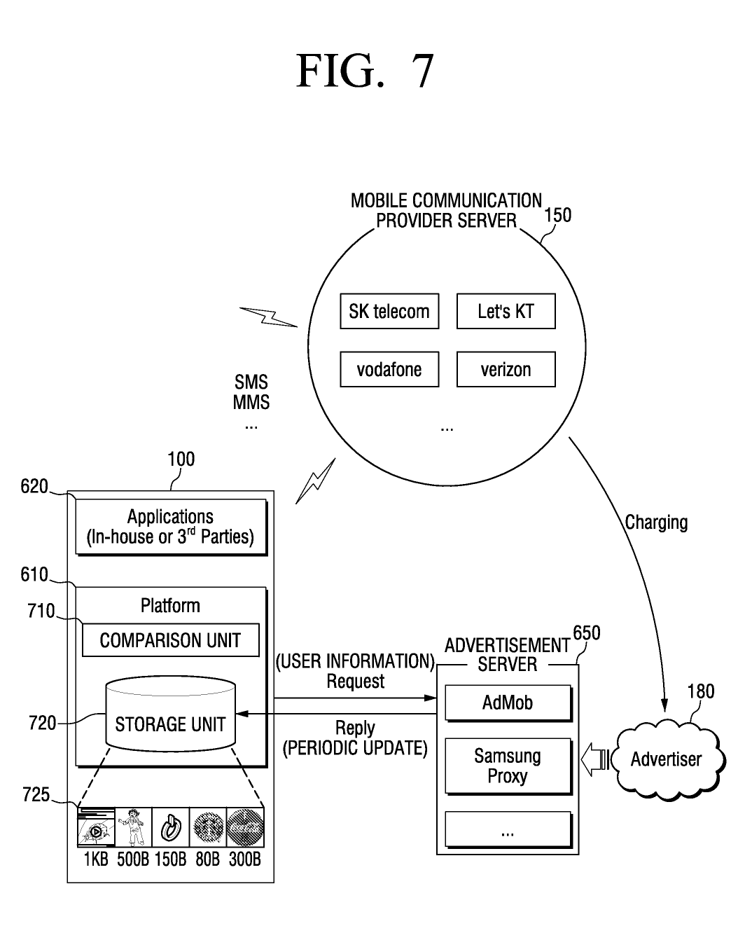

FIG. 7 is a view illustrating a data service providing system including an advertisement server 650 according to an embodiment of the present invention.

As shown in FIG. 7, a terminal A 100 includes a platform unit 610 and an application unit 620. The platform unit 610 includes a comparison unit 710 and a storage unit 720. The comparison unit 710 compares a data generation quantity and a data assignment quantity.

The storage unit 720 stores various advertisement contents 725 received from an advertisement server 650.

Unlike the data service providing system of FIG. 1, the data service providing system of FIG. 7 includes the advertisement server 650. The advertisement server 650 receives a request to generate advertisements by various advertisers, generates an advertisement content suitable for the terminal A 100, and transmits the generated advertisement to the terminal A 100. As shown in FIG. 7, the advertisement server 650 periodically updates the advertisement content of the terminal A 100 periodically.

Also, the terminal A 100 transmits, to the advertisement server 650, user information corresponding to the terminal A 100. The user information may include information such as age, sex, taste, etc. of the user.

The advertisement server 650 selects an advertisement content suitable for the user based on the user information and transmits the selected advertisement content to the terminal A 100 to update the terminal A 100.

A process of providing a data service to send a message and a process of charging for the data service of the terminal A 100, the mobile communication provider server 150, and the advertiser 180 are the same as described in FIG. 1.

As described above, the advertisement server 650 incorporates the advertisements of the various advertisers, selects the advertisement based on the user information, and updates the advertisement of the terminal A 100.

Although the data service described in the above embodiment of the present invention is a service for sending a message, any other service may be applied in accordance with embodiments of the present invention. Any service can be applied that can offer a discount on a data service charge by inserting an advertisement content.

Also, any user terminal that can provide a data service and receive and display an advertisement content may be applied as the terminal A 100. For example, the user terminal 100 may be an MP3 player, a Portable Media Player (PMP), a mobile phone, and a Personal Digital Assistant (PDA).

According to the above-described embodiments of the present invention, methods and systems for providing the data service, in which content that is assigned an quantity sufficient for using the data service is selected by a user, the data generation quantity, which is a quantity of data generated by a user, is compared with the data assignment quantity which is a quantity assigned to the content, and the service for the data generated by the user is performed based on a result of comparison, are provided so that the user can receive a discount on the data service charge by adding the advertisement content to the message.

The foregoing embodiments and advantages of the present invention are merely and are not to be construed as limiting the present inventive concept. The embodiments of the present invention can be readily applied to other types of apparatuses. The description of the embodiments of the present invention is intended to be illustrative, and not to limit the scope of the claims, and many alternatives, modifications, and variations will be apparent to those skilled in the art.

What is claimed is:

1. A method for providing a data service in a terminal, the method comprising:
selecting a content that is assigned a data assignment quantity indicating a quantity sufficient for using a service;
comparing a data generation quantity indicating a quantity of data generated by a user and the data assignment quantity; and
performing the service for the data generated by the user according to a result of the comparison.

2. The method as claimed in claim 1, wherein performing the service includes transmitting data for performing the service to an external server,
wherein the data for performing the service includes the selected content.

3. The method as claimed in claim 2, wherein the service is at least one of a Short Message Service (SMS), a Multimedia Messaging Service (MMS), and an emailing service.

4. The method as claimed in claim 3, wherein performing the service comprises:
including the selected content in message text of a service selected from among the SMS, the MMS, and the emailing service; and
transmitting the message text of the selected service to the external server with the selected content included in the message text.

5. The method as claimed in claim 1, wherein performing the service includes transmitting, to the external server, information for performing the service, information on the data generation quantity, and the information on the data assignment quantity.

6. The method as claimed in claim 5, wherein, if the data generation quantity is less than or equal to the data assignment quantity, the external server charges a main agent of the content for the service.

7. The method as claimed in claim 5, wherein, if the data generation quantity is greater than the data assignment quantity, the external server charges a main agent of the content and charges the user for a remaining quantity after the data assignment quantity is deducted from the data generation quantity.

8. The method as claimed in claim 7, wherein the content is an advertisement content, and the main agent of the content is an advertisement agent.

9. The method as claimed in claim 1, wherein the content includes at least one of a still image content, a moving picture content, and a media file.

10. The method as claimed in claim 1, wherein selecting the content includes selecting a plurality of contents, each of which is assigned a respective data assignment quantity,
wherein the data assignment quantity is a sum of the respective data assignment quantities.

11. A method for providing a data service by an external server that is included in a data service providing system including a terminal and the external server, the method comprising:
receiving, from the terminal, a data generation quantity indicating a quantity of data generated by a user, a data assignment quantity indicating a quantity assigned to a content, and a service request for performing a service for data generated by the user;
performing the requested service; and
charging for the service using the data generation quantity and the data assignment quantity.

12. The method as claimed in claim 11, wherein the service is at least one of a Short Message Service (SMS), a Multimedia Messaging Service (MMS), and an emailing service.

13. The method as claimed in claim 12, wherein receiving the information includes receiving message text of a service selected from among the SMS, the MMS, and the emailing service, with the selected content included in the message text,
wherein performing the requested service includes transmitting the message text of the selected service to a destination apparatus with the selected content included in the message text.

14. The method as claimed in claim 11, wherein the receiving comprises receiving information for performing the service, information on the data generation quantity, and information on the data assignment quantity from the terminal.

15. The method as claimed in claim 14, wherein charging for the service includes, if the data generation quantity is less than or equal to the data assignment quantity, charging a main agent of the content for the service.

16. The method as claimed in claim 14, wherein charging for the service includes, if the data generation quantity is greater than the data assignment quantity, charging a main agent of the content according to the data assignment quantity and charging the user according to a remaining quantity after the data assignment quantity is deducted from the data generation quantity.

17. The method as claimed in claim 16, wherein the content is an advertisement content, and
wherein a main agent of the content is an advertisement agent.

18. The method as claimed in claim 11, wherein the content is at least one of a still image content, a moving picture content, and a media file.

19. The method as claimed in claim 11, wherein the terminal selects a plurality of contents, each of which is assigned a respective data assignment quantity,
wherein the data assignment quantity is a sum of the respective data assignment quantities.
